(19) United States
(12) Patent Application Publication
(10) Pub. No.: US 2011/0259439 A1
(43) Pub. Date: Oct. 27, 2011

(54) DEVICE IN WHICH TO SUBJECT AN IMPLANTABLE MEDICAL PRODUCT TO LOADS

(75) Inventor: Peter Eduard Neerincx, Oisterwijk (NL)

(73) Assignee: TECHNISCHE UNIVERSITEIT EINDHOVEN

(21) Appl. No.: 13/060,133

(22) PCT Filed: Aug. 20, 2009
(86) PCT No.: PCT/NL09/50503

§ 371 Date: May 4, 2011

(30) Foreign Application Priority Data
Aug. 25, 2008 (NL) 1035860

(51) Int. Cl. F16K 15/20

(52) U.S. Cl. 137/223

(57) ABSTRACT

A device is provided in which an implantable medical product is subjected to loads. The device includes a continuous channel with a wall, in which a liquid is to flow in a flow direction; a first liquid chamber is provided with an adjustable volume, a product chamber is provided for accommodating the medical product that is to be put under load, a second liquid chamber is provided with an adjustable volume, and a valve device is provided with a valve member which, in a first state, closes the channel and, in a second state, allows channel flow. The device includes a flow mechanism configured to cause liquid to flow through the channel in the flow direction by changing the volume of the first liquid chamber as well as an operational mechanism configured to achieving a continuously variable adjustment of the valve member between the first state and the second state.

The invention relates to a device in which to subject an implantable medical product to loads, comprising a continuous channel with a wall, in which a liquid is to flow in a flow direction and, consecutively in or along said channel as seen in the flow direction of the liquid, a first liquid chamber with an adjustable volume, a product chamber for accommodating the medical product that is to be put under load, a second liquid chamber with an adjustable volume, and a valve device provided with a valve member which in a first, closed state closes off the channel and in a second, open state allows a flow through the channel, which device further comprises flow means for causing the liquid to flow through the channel in the flow direction by changing the volume of the first liquid chamber.

The invention relates in particular, though not exclusively, to a bioreactor for manufacturing an implantable medical tissue engineered product. The manufacturing process of an implantable medical tissue engineered product comprises the stages of growing, conditioning, and testing. During these stages the product to be manufactured is subjected to a certain loading pattern in a bioreactor. In the case of an implantable medical product (not of the tissue engineered type) such as, for example, an artificial heart valve, the product is put under load in a device to which the present invention relates, so that the product can be tested for properties such as durability.

A so-termed scaffold is placed in the product chamber of the bioreactor for the manufacture of a medical tissue engineered product such as, for example, a heart valve. Cells of the patient are placed on this scaffold, which consists mainly of biodegradable material and has the shape of the desired product. The multiplication of cells and the resulting growth of the product on the scaffold is stimulated in the bioreactor in that the physiological conditions such as they prevail in the human body are simulated to a higher or lesser degree during the consecutive stages of the manufacturing process. The material of the scaffold is gradually broken down and a product of natural body cells of the patient is obtained that can grow along with the patient, can assume other shapes, and can recover. After implantation of the product into the patient's body, moreover, the risk of rejection of the product by the patient's body is strongly reduced or even nil because the product is completely formed by cells of the patient him/herself.

U.S. Pat. No. 5,899,937 discloses a device as described in the introduction. Said document describes a device by means of which cardiac tissue to be implanted can be subjected to a physiological pulsatory flow. The device comprises bellows for causing a liquid to flow through the cardiac tissue present in a test section, wherein a combination of a plunger pump and a motor enlarges or reduces an external liquid volume, as a result of which the bellows are compressed or expanded, respectively. Included downstream of the test section there is a column of liquid of a certain height to which a cylinder is connected, which cylinder is provided with a membrane. This membrane expands when the bellows are compressed, as a result of which liquid flows from the bellows through the test section into the cylinder, and springs back when owing to an expansion of the bellows the liquid flows through a return channel back into the bellows. The return channel between the cylinder and the bellows comprises a one-way valve. This one-way valve is either closed, i.e. when liquid flows from the bellows through the test section to the cylinder, or fully open, when the liquid flows from the cylinder back into the bellows.

A major disadvantage of the device described in U.S. Pat. No. 5,899,937 is that the cylinder is accommodated at a certain height relative to the test section and the bellows. This is necessary in this known device to be able to simulate the physiological conditions prevailing in the human body with sufficient accuracy. This is the usual construction in practice, and said height is approximately 1.2 m. This need not be a disadvantage in principle for experiments, for example in a laboratory. The demand for bioreactors is expected to increase strongly in the future. It is especially the comparatively great height at which the cylinder is located, however, that renders the known device unsuitable for production and use on a large scale.

The present invention accordingly has for its object to improve on the disadvantage mentioned above, whether or not in one of its preferred embodiments. More in particular, the invention aims to present a compact device that can be handled in a simple manner and that is suitable for production and use on a large scale. This object is achieved in that the device comprises operational means for allowing a continuously variable adjustment of the valve member between the first state and the second state. The invention is herein based on the inventive perception that, in a device for subjecting an implantable medical product to loads comprising two liquid chambers of adjustable volume, the use of a valve device with a continuously adjustable valve member renders it possible to adjust three important parameters variably, continuously, and independently of one another, i.e. the flow of liquid through the medical product, the liquid pressure upstream of the medical product, and the liquid pressure downstream of the medical product. A pressure drop across the valve device can in fact be generated now by means of the continuously and variably adjustable valve member, which will result in a certain liquid pressure upstream of the medical product and a certain liquid pressure downstream of the medical product. Physiological conditions such as they are present in the human body can thus be accurately simulated. It is no longer necessary to place a liquid chamber at a comparatively great height. The device can be made much more compact as a result of this and is thus considerably more suitable for production and use on a large scale.

Preferably, the valve device comprises an at least partly flexible connecting member for connecting the valve member to a rigid portion of the wall of the continuous channel. The valve member is movably accommodated in the valve device owing to the use of the flexible material in the connecting member of the valve member, but a generation of wear particles such as those caused by a mutual chafing of materials in standard connecting elements such as hinges is absent. The interior of a bioreactor must be sterile and it is accordingly imperative that no or at least as few as possible contaminating particles are generated inside the bioreactor, so that any deposit thereof on the (tissue engineered) medical product to be put under a load is also nil or at a minimum.

It is furthermore preferable that the flexible portion of the connecting member is resilient. It is achieved thereby that there is one (neutral) preferred position of the valve member. The position of the valve member is thus known in the absence of external loads. This position may be, for example, fully closed, fully open, or an intermediate position. Preferred is a position which lies approximately half-way between the fully closed and the fully open position. The deformation of the connecting member required for achieving the fully closed and the fully open position starting from this neutral position is a minimum in this case.

The advantages of an at least partly flexible connecting member come to the fore especially if the flexible portion of the connecting member constitutes a portion of the wall of the channel. The valve member with the connecting member can be included in the valve device in a simple manner as a result of this, without the use of additional components for fastening the connecting member to the wall, which obviously has a favourable effect on the cost price.

If an at least partly flexible connecting member is used, it is highly advantageous when the operational means are adapted to deform the flexible portion of the connecting member so as to adjust the position of the valve member. With this construction the interior space of the channel can be separated from the outer atmosphere in a simple manner. The sterility of the liquid in the channel can be safeguarded thereby since there is no need for any moving part that extends, for example, through a wall portion of the valve device for operating the valve member. It suffices to deform the flexible portion of the connecting member.

Preferably, the operational means comprise a pneumatic pressure chamber at the outer side of the flexible portion of the connecting member, and pneumatic pressure means for changing the pressure in said pneumatic pressure chamber. As was described above, the flexible portion of the connecting member renders it possible to separate the interior of the channel from the outer atmosphere. The use of pneumatic pressure means such as, for example, compressed air renders a simple, inexpensive, and clean manner of operation of the valve member of the valve device possible.

Preferably, furthermore, the pneumatic pressure chamber comprises a surrounding wall which is detachably provided at the outer side of the flexible portion of the connecting member. The separation between the inner space of the channel and the outer atmosphere makes it possible to design the surrounding wall of the pressure chamber such that said pressure chamber, preferably complete with any additional components such as pneumatic supply lines, can be uncoupled from the valve device in a simple manner. This considerably improves the ease of handling of the device.

Preferably, the valve member is at least partly flexible, more preferably resilient. This has the major advantage that on the one hand the valve member closes off the liquid passage effectively in the closed state without any additional provisions such as O-rings being necessary for this. On the other hand, the valve member can be manufactured together with the flexible connecting member as one integral component if in accordance with a preceding embodiment a flexible connecting member is used. Both effects favourably affect the cost price of the device.

A liquid flows from the first liquid chamber through the product chamber, in which the heart valve is present, to the second liquid chamber during the (simulated) systole in the manufacture of a heart valve in a bioreactor. The heart valve is closed during the (simulated) diastole because the pressure behind the heart valve, i.e. the simulated aortic pressure, is higher in this phase than the pressure in front of the heart valve, i.e. the simulated left ventricle pressure. This forces the liquid to flow back through the valve device into the first liquid chamber. It is very advantageous for an accurate control of the liquid flow, for example in the case of the simulated diastole mentioned above, if the flow means are additionally adapted to cause liquid to flow through the channel in the flow direction by changing the volume of the second liquid chamber.

For the same reasons as those relating to the flexible connecting member of the valve device as described above, it is highly advantageous if at least one of the liquid chambers comprises an at least partly flexible, more preferably resilient wall.

It is furthermore advantageous for practical and cost reasons if the flexible wall of at least one of the liquid chambers is made of the same material as a flexible portion of the connecting member and/or of the valve member.

The advantage of the at least partly flexible wall of a liquid chamber becomes particularly apparent if the flow means are adapted to deform the flexible wall of at least one of the liquid chambers so as to change the volume of the relevant liquid chamber or chambers. The sterile environment in the channel of the device can thus be safeguarded in a simple manner because the changing of the volume is not accompanied by components rubbing against each other such as is the case, for example, in a cylinder-piston construction.

As in the valve device, it is furthermore favourable if the flow means comprise at least one further pneumatic pressure chamber at the outer side of the flexible wall of at least one of the liquid chambers, and further pneumatic pressure means for adjusting the pressure in said further pneumatic pressure chamber or chambers. The use of pneumatic pressure means such as, for example, compressed air renders it possible to set the volume of the relevant liquid chamber in a simple, inexpensive, and clean manner.

Preferably, moreover, the at least one further pneumatic pressure chamber comprises a surrounding wall that is detachably provided against the outer side of the flexible wall of at least one of the liquid chambers. Since the channel of the valve device is fully closed off against the outer atmosphere, the surrounding wall of the pressure chamber, preferably complete with any additional components such as a pneumatic supply line, can be uncoupled from the relevant liquid chamber in a simple manner.

An additional advantage is obtained if the flexible wall of at least one of the liquid chambers has a substantially convex shape in the non-loaded state. Such a shape can be readily manufactured, for example by injection moulding. The specific shape does not adversely affect the adjustment possibilities but it does have a cost reducing effect. In addition, the deformation region is small in the case of a convex shape, which means that the rigidity of the flexible wall is determined by the wall thickness in the deformation region only.

If the wall thickness of the convex flexible wall increases in a direction away from the top, the further advantage is obtained that the predictability of its deformation increases. This benefits the accuracy of the control of the relevant parameters (liquid flow through the product or liquid pressure in the relevant liquid chamber).

Alternatively or in combination with the increasing wall thickness described above, it is furthermore advantageous if the convex flexible wall is locally provided with thickened portions for guiding deformation regions towards non-thickened portions of the convex flexible wall in use. Research has shown that the predictability of the deformation of the convex flexible wall is definitely enhanced when the thickened regions extend from the top of the convex shape in the form of alternate thickened and non-thickened wedge-shaped regions or ribs.

It is furthermore advantageous if that portion of the wall of the liquid chamber that is located opposite the convex flexible wall has a convex shape. As a result of this a sufficient clearance will remain present at all times between the (mirrored) convex flexible wall and the oppositely located convex portion of the wall of the liquid chamber during deformation of the convex flexible wall, without the liquid chamber becoming unnecessarily large. The convex shape also prevents or at least strongly reduces the formation of regions containing stagnant liquid. The local formation of regions with stagnant liquid may occur in particular in the case of more angularly shaped spaces.

Preferably, furthermore, that portion of the wall of the liquid chamber that is located opposite the convex flexible wall is rigid. If the oppositely located portion of the wall of the liquid chamber is rigid, this oppositely located wall, owing to the absence of deformation therein, will have no adverse superimposing effect on the (control of the) deformation of the flexible wall of the liquid chamber.

In a very simple and accordingly inexpensive and advantageous embodiment, the liquid chambers are defined by a first housing part and a second housing part, which parts are interconnected in a liquid-proof manner.

Preferably, furthermore, the device comprises sealing means between the first housing part and the second housing part, which means comprise two lips which enclose a volume of reduced pressure between the two lips for achieving a suction joint between the first housing part and the second housing part. The use of lip seals with a volume of reduced pressure in between renders it unnecessary in principle to provide a special reinforcement of the walls adjacent the seal and to clamp the two housing parts against one another with additional clamping means. It is the reduced pressure alone that provides a considerable clamping force. Also, impurities cannot enter the interior of the device because the pressure between the lips of the lip seal is lower than the pressure inside the device in principle. The latter aspect is very important in view of the required sterility of the interior of the device.

In order to obtain a cost-effective device without detracting from the performance thereof, it is highly favourable if the first housing part is injection-moulded and at least partly rigid, and the first housing part comprises at least the flexible portion of the connecting member of the valve device and/or the flexible wall of the first and/or the second liquid chamber. The integration of rigid and flexible portions in a single injection-moulded product has the advantage that only one expensive mould is required. In addition, the amount of assembly work is considerably reduced, which obviously also has a strong cost-reducing effect.

A still further cost reduction can be obtained if the device consists substantially of two injection moulded, mutually mating housing parts. It is favourable in this respect if the rigid portion of the wall of the liquid chamber is integral with the first housing part, whereas the flexible wall of said chamber is integral with the second housing part.

Preferably, furthermore, the second housing part is injection-moulded, comprises the rigid portion of the wall of the liquid chamber whose flexible wall is integral with the first housing part, and comprises the flexible wall of the liquid chamber whose rigid wall portion is integral with the first housing part. The device can be constructed from these two housing parts in a simple manner, given such a distribution of functions over the two housing parts.

This distribution of functions over the two housing parts also renders it possible that, in a further preferred embodiment, the first housing part and the second housing part have the same shape or are even fully identical. This means in the case of injection moulding that only one injection mould need be used for the two housing parts, which is again very favourable for the cost price. The device according to the invention has such a low cost price that it is highly suitable for disposable use. This has the major advantage that a transmission of contaminations from one product to the next, and thus from one patient to the next, can be prevented in that the device is used for putting only one product under load.

It is furthermore favourable if the device comprises at least one housing part that is injection-moulded, for which purpose an injection mould is provided that is constructed for injection moulding a plurality of housing parts in one and the same injection moulding step, preferably simultaneously. This advantage manifests itself in particular in the case of small to very small versions of the device. If a mould is designed with which several housing parts of the device can be injection moulded simultaneously, a major cost reduction can be achieved.

In a further embodiment, the continuous channel comprises a mixing device comprising a three-dimensional mixing channel for achieving a static mixing of at least two liquids. It is desirable in many cases in a (bio) reactor that the liquid present therein is refreshed through mixing of newly supplied liquid with the liquid present in the reactor, or that additives are added to the liquid in the reactor, also by mixing. It is advantageous in these cases if a static mixer as described above is used because of the sterility, but also for reasons of cost. Such a mixer is known per se from US patent application US 2007/0177458. The mixing channel may obviously also be provided in a bypass of the continuous channel so as to mix a portion of the liquid further, or to mix it with a liquid provided from the exterior in that location.

It is advantageous in this respect if the three-dimensional mixing channel is located partly in the first housing part and partly in the second housing part. The three-dimensional mixing channel may be readily integrated with the device if it is situated at the transition between the two housing parts such that the mixing chamber lies partly in the first and partly in the second housing part, as described above. The mixing channel is thus given its final shape when the two housing parts are assembled together.

Such a mixer is also highly suitable for use in a miniaturized version of the bioreactor. Such a very small embodiment is highly suitable, for example, for synthesizing DNA, for example. It is noted in this connection that the use of a mixer is also possible in devices according to the prior art and also in simpler devices than the ones to which the opening paragraph relates, i.e. devices comprising a continuous channel in which a liquid is to flow in a flow direction and, in or along said channel, at least one liquid chamber with an adjustable volume and a valve device provided with a valve member which in a first, closed state closes off the channel and in a second, open state allows a flow through the channel, which device further comprises flow means for causing the liquid to flow through the channel in the flow direction by changing the volume of the first liquid chamber, and a mixing device comprising a three-dimensional mixing channel for achieving a static mixing of at least two liquids. The flow means therein are preferably constructed as described further above.

The invention further provides a method of manufacturing a device according to the present invention, comprising the step of injection moulding the first housing part and/or the second housing part in one mould, wherein the material for the flexible portions and the material for the rigid portions are injected in the same injection moulding step, preferably simultaneously. This manufacturing process means that the flexible and rigid portions of a relevant housing part are connected to one another in a simple manner as early as in the injection moulding stage.

The invention further provides a method of operating a device according to the present invention, comprising the step of mutually differently changing the volume of the first liquid chamber and the volume of the second liquid chamber so as to change the liquid pressure in at least one liquid chamber of the device. The use of a continuously adjustable valve member in a device according to the present invention can generate a pressure drop across the valve device. It is highly advantageous for an accurate simulation of the physiological conditions such as they prevail in the human body that in addition thereto a pressure level can be set in the first and/or the second liquid chamber. The control of, for example, the pressure in the first liquid chamber on the one hand and of the pressure drop across the valve device on the other hand at the same time defines the pressure in the second liquid chamber, which latter pressure is the simulated aortic pressure.

The invention will now be described in more detail in a description of a preferred embodiment of a device according to the invention with reference to the following figures, in which:

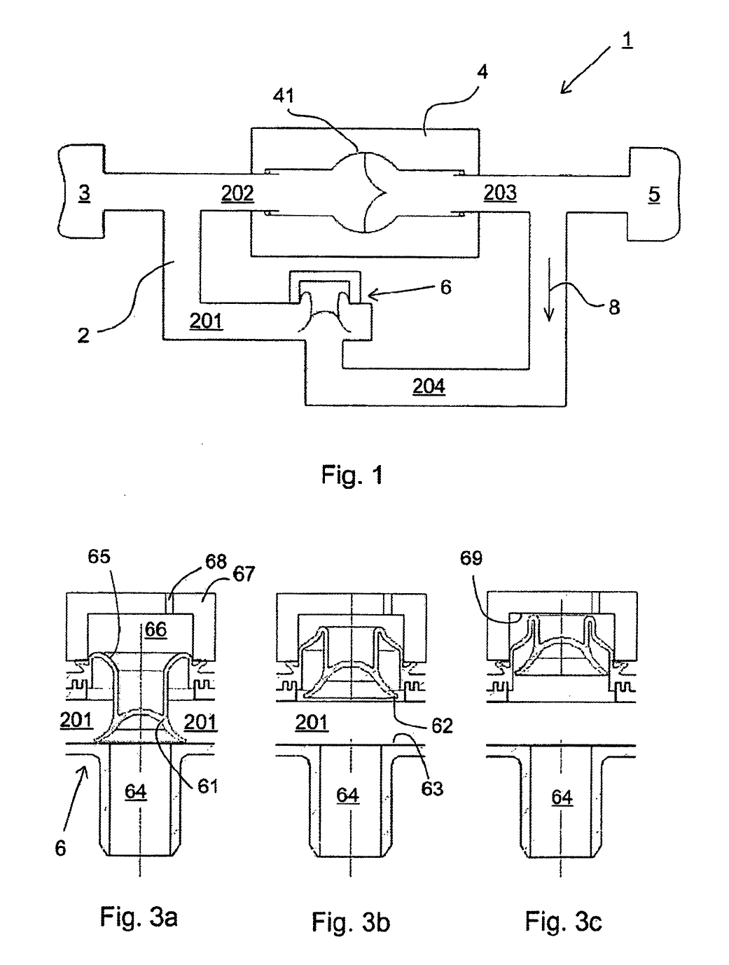

FIG. 1 diagrammatically shows a preferred embodiment of a bioreactor according to the invention;

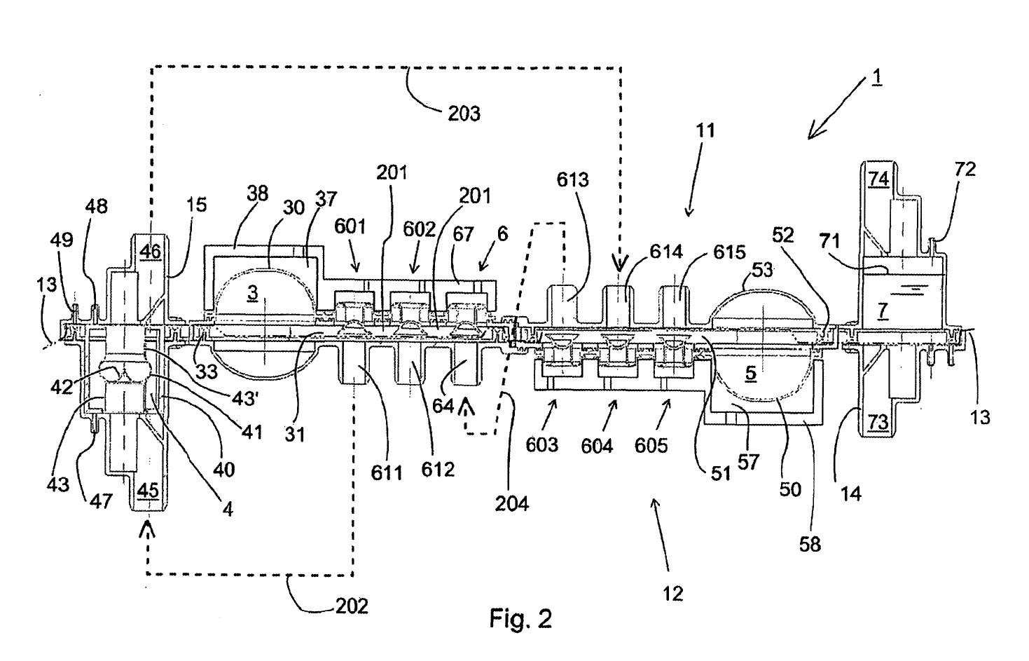

FIG. 2 is a cross-sectional view of the bioreactor of FIG. 1 wherein for a better understanding essential components have been brought into the plane of the drawing;

FIGS. 3a, 3b, and 3c are cross-sections of a valve device of the bioreactor of FIG. 1 with the valve device in the closed, largely open, and fully open state;

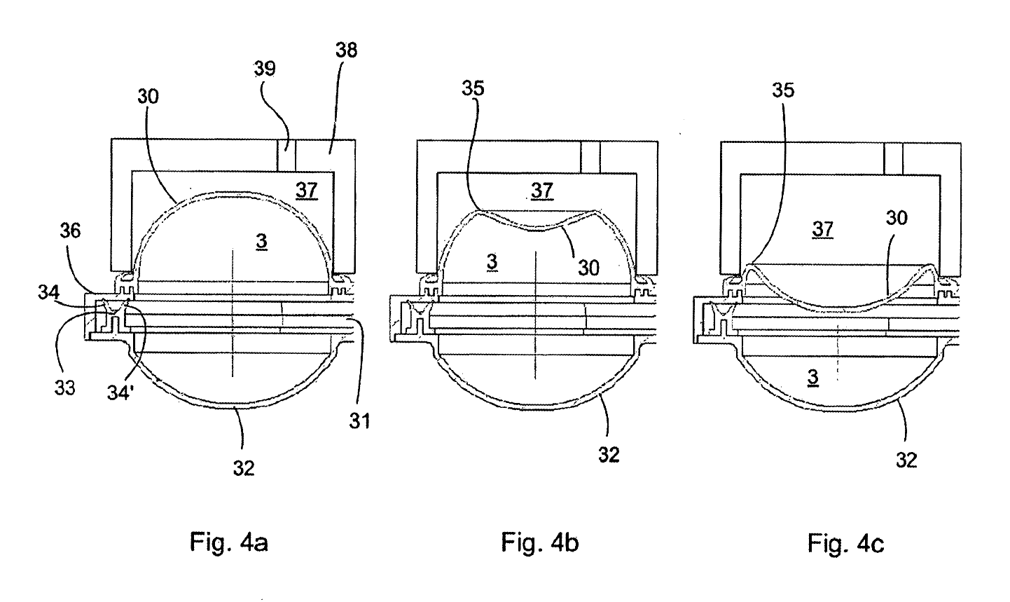

FIGS. 4a, 4b, and 4c are cross-sections of a liquid chamber of the bioreactor of FIG. 1 in different stages of compression of the flexible wall of the liquid chamber;

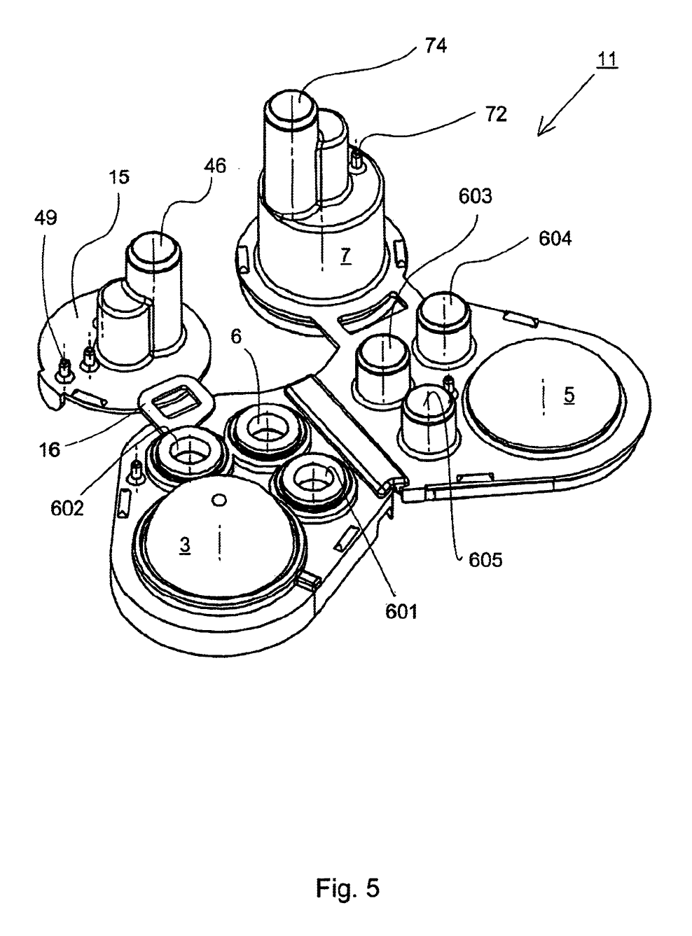

FIG. 5 is a 3D representation of one of the two basic components of the bioreactor of FIG. 1;

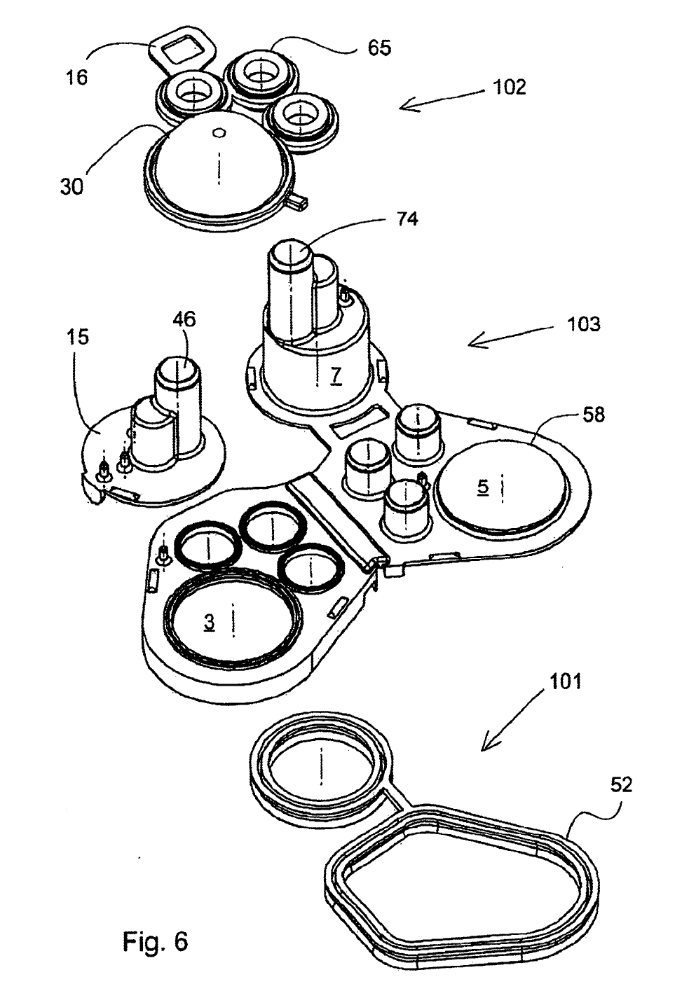

FIG. 6 shows the basic component of FIG. 5 with flexible and rigid portions of the basic component being separately depicted;

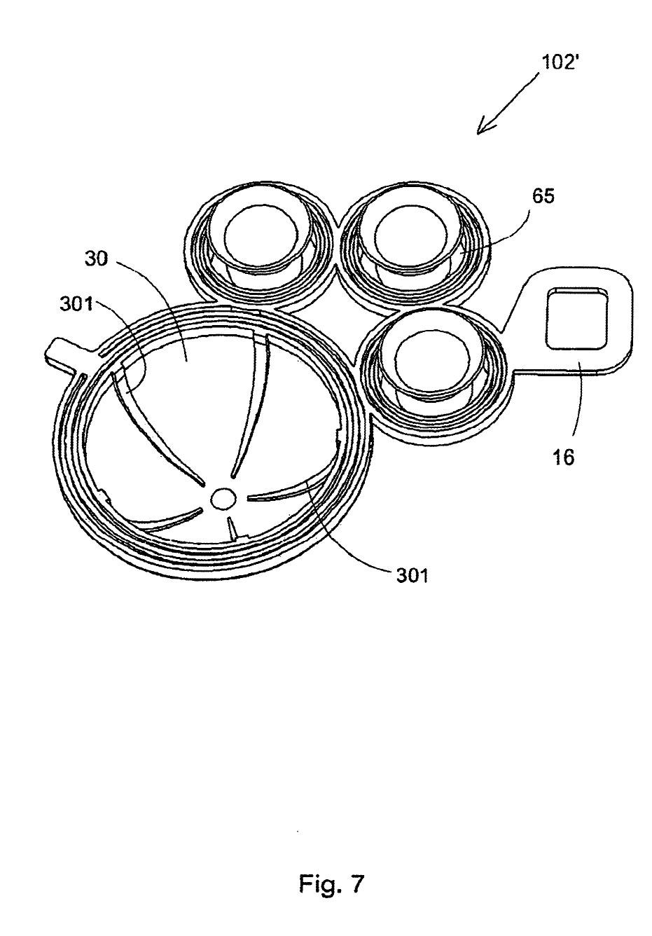

FIG. 7 shows an alternative embodiment of a flexible portion of the basic component of FIG. 5;

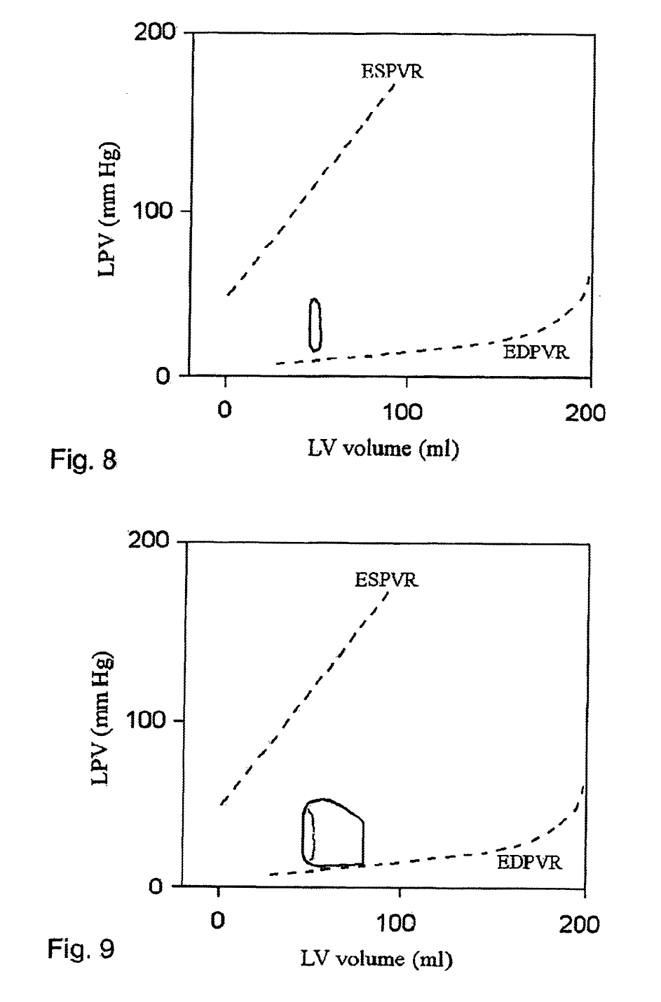

FIG. 8 is a graph of the growing process of a heart valve wherein the left ventricle pressure is plotted as a function of the left ventricle volume;

FIG. 9 is a graph of the conditioning process of a heart valve wherein the left ventricle pressure is plotted as a function of the left ventricle volume;

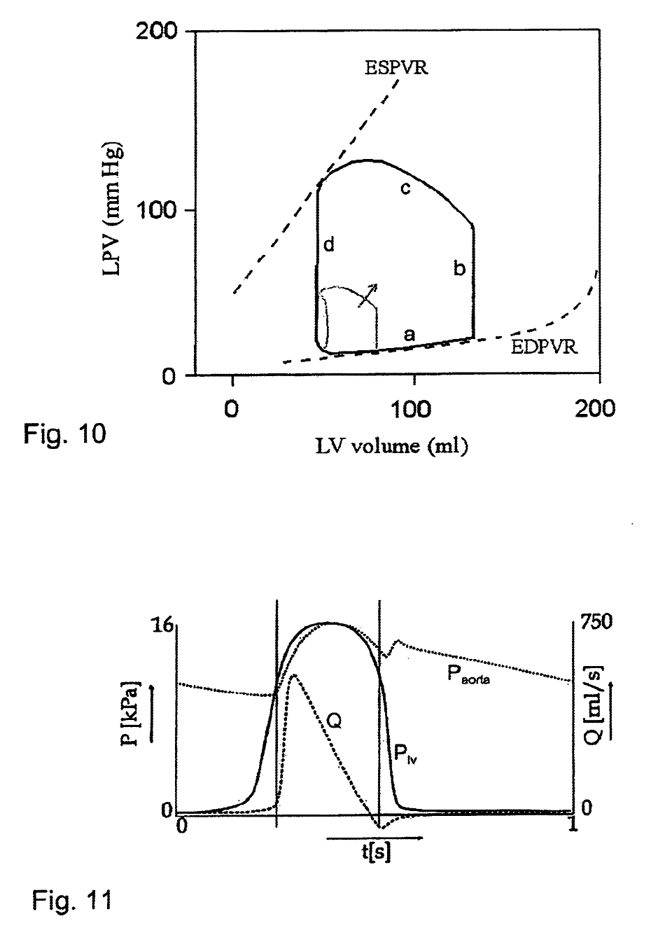

FIG. 10 is a graph of the testing process of a heart valve wherein the left ventricle pressure is plotted as a function of the left ventricle volume; and

FIG. 11 is a graph of a heart beat wherein pressures in the aorta and the left ventricle are plotted as a function of time and wherein also the volume flow through the aortic valve is plotted as a function of time.

The bioreactor 1 is diagrammatically depicted in FIG. 1 for a clear visualization of the main components and their mutual positions in the bioreactor. The bioreactor 1 comprises a continuous channel 2 in which a nutrient liquid can circulate in a flow direction 8. Viewed in/along the continuous channel 2 in the flow direction 8 we find in that order a first liquid chamber 3, a product chamber 4, a second liquid chamber 5, and a valve device 6. The medical tissue engineered product 41 to be grown is present in the product chamber 4. In the example shown in FIGS. 1 and 2, said medical tissue engineered product 41 is a heart valve (diagrammatically depicted), more specifically an aortic valve, which is oriented in the channel 2 such that it allows liquid to pass in the flow direction 8 only. This means that the heart valve opens when the liquid pressure in the first liquid chamber 3 becomes higher than the liquid pressure in the second liquid chamber 5 and closes when the liquid pressure in the second liquid chamber 5 becomes higher than the liquid pressure in the first liquid chamber 3.

FIG. 2 is a cross-sectional view of the bioreactor 1. In this cross-section a number of relevant channel components have been diagrammatically indicated by dashed lines. The reference numerals belonging to these channel components are also present in FIG. 1. The direction of flow of the liquid through the relevant channel component has been indicated by arrows at the beginning and end of these lines. The bioreactor 1 comprises two injection-moulded housing parts 11 and 12. All that lies above the indicative dash-dot line 13 belongs to the housing part 11 and all below said line belongs to the housing part 12. The housing part 12 comprises most of the product chamber 4, whereas a portion of identical shape in the housing part 11 serves as a liquid storage chamber 7. The housing parts 11 and 12 are identical, the housing part 11 having been placed on the housing part 12 after rotation through 180° about a vertical axis (not shown). This results in a point-symmetrical assembly. Injection-moulded lip seals such as, for example, those referenced 33 (see also FIG. 4a) have been integrated with the housing parts 11 and 12 so that they also form part of the relevant housing part 11 or 12. These lip seals render it possible for the housing parts 11 and 12 to be interconnected by means of an underpressure between the lips of the lip seal in a liquid-proof manner. An underpressure can be applied between the two flexible lips of the lip seal between the two housing parts of product chamber 4, for example via a gate 49.

An adapter 40 is arranged in the product chamber 4, in which adapter the medical tissue engineered product 41 is present. A heart valve is diagrammatically indicated, more specifically an aortic valve in this case. It is a characteristic of an aortic valve that it allows liquid to pass in one direction only, as was noted above. The aortic valve is oriented in the product chamber 4 such that it allows liquid to flow from an inlet gate 45 to an outlet gate 46. The aortic valve comprises three so-termed leaflets 42 which are connected to artery parts 43, 43′. The artery parts 43, 43′ can be connected to existing tissue in the operation in which the manufactured aortic valve is implanted into the human body.

The channel portion 202 is connected between the inlet gate 45 of the product chamber 4 and a gate 611, thus linking the product chamber 4 to the first liquid chamber 3 and to the channel portion 201 (cf. FIG. 1). The channel portion 203 lies between the outlet gate 46 of the product chamber 4 and a gate 614, thus linking the product chamber 4 to the second liquid chamber 5 and to the channel portion 204. The product chamber 4 further comprises two gates 47, 48 for refreshing liquid present in the adapter 40, which is arranged outside the product to be manufactured therein. The gate 47 serves as an inlet and is connected to a gate 612 via a channel portion that is not shown. The gate 48, i.e, the outlet, is connected to a gate 74 of the liquid storage chamber 7 via a channel portion that is also not shown.

The first liquid chamber 3 is in communication with the channel portions 201 and 202 via a passage 31. To enhance the functionality of the bioreactor, the flow through the channel portion 202 can be interrupted by a valve device 601. It should be noted here that the valve device 601 is in fact only capable of closing gate 611; the connection between channel 201 and the first liquid chamber 3 (passage 31) is not significantly obstructed by the presence of the valve device 601. In other words: when the valve device 601 is closed, the gate 611 is closed and no liquid can flow from channel 201 to channel 202, but liquid can flow from channel 201 to the first liquid chamber 3 and vice versa. A further valve device 602 can open or close a gate 612, which is in fact a branch-off of channel portion 201. The valve device 6, furthermore, is included between the channel portions 204 and 201 (see also FIG. 1), such that the channel portion 204 links the gate 64 of the valve device 6 to the gate 613 of the valve device 603.

The valve device 6, which is shown in more detail in FIGS. 3a, 3b, and 3c and which will be described in more detail below, interconnects the first liquid chamber 3 and the second liquid chamber 5. As is apparent from FIG. 2, it is actually not important by means of which of the valve devices 601, 602, or 6 the first liquid chamber 3 is coupled to the second liquid chamber 5 (in accordance with the diagrammatic picture of FIG. 1) because the valve devices 601, 602, 6 are of identical construction. The valve device 603, however, is less suitable for serving as the valve device as meant in FIG. 1. This is because the liquid flows in an opposite direction through the valve device 603 compared with the direction of flow in the valve device 6. Experiments have shown that the stability of the valve device control is at its highest when the liquid flows through the valve device in the direction obtaining in valve device 6, i.e. from gate 64 along valve member 61 to channel 201 in the case of valve member 6. See also FIGS. 3a, 3b, and 3c.

The second liquid chamber 5 has the same construction as the first liquid chamber 3. The channel portion 203 connects the second liquid chamber 5 to the product chamber 4, a valve device 604 being optionally included for closing off the channel portion 203, if so desired. The gate 51 of the second liquid chamber 5 connects the channel portions 204 and 203 to the second liquid chamber 5. The second liquid chamber 5 further comprises a gate 615 that can be closed by a valve device 605 and by which the second liquid chamber 5 can be connected to the liquid storage chamber 7 (connection channel not shown in any detail).

The liquid storage chamber 7 has the same construction as the product chamber 4, but no adapter 40 for holding a medical tissue engineered product has been placed in the liquid storage chamber 7. The liquid present in the liquid storage chamber 7 can ‘breathe’ thanks to its free surface area 71. It was assumed in FIG. 2 by way of example that the bioreactor is oriented such that the gate 74 is at the upper side and the gate 72 is at the lower side. Any orientation of the bioreactor is in fact entirely acceptable as long as the free surface area 71 is inside the liquid storage chamber 7. The air in the liquid storage chamber 7 is in communication with the outer air via a gate 72 and an air filter (not shown) necessary for maintaining the sterile atmosphere inside the bioreactor. A gate 73 of the liquid storage chamber 7 is in communication with gate 615 of the second liquid chamber 5. When the valve device 605 is set in the open position, the bioreactor can be filled with liquid, for example. Filling of the bioreactor with liquid is done through gate 74 of the liquid storage chamber 7.

As is visible in more detail in FIGS. 3a, 3b, and 3c, the valve device 6 is provided with a valve member 61 that is preferably made from a flexible material such that it applies itself with its closing edge 62 optimally against the opposed channel wall 63 in the closed state shown in FIG. 3a, so that no liquid can flow through the valve device via gate 64. The valve member 61 is accommodated in the valve device 6 by means of a flexible connecting member 65, which connecting member in fact forms part of the wall of the valve device 6. At the outer side of the connecting member 65 there is a pneumatic pressure chamber 66 which is separated from the outer atmosphere by a pressure chamber housing 67 and into and from which compressed air can be introduced and discharged through a gate 68. Changing of the pressure in the pneumatic pressure chamber 66 will deform the connecting member 65, which in its turn changes the position of the valve member 61. FIG. 3a shows the fully closed position and FIG. 3b a largely open position of the valve member 61 and accordingly of the valve device 6. It is important to note here that in the fully closed position of the valve device 6 it is only gate 64 that is closed, The liquid flow in the channel 201, .i.e. from left to right and back through the valve device 6 in FIG. 3a, is not significantly obstructed by the closed position. FIG. 3c shows the fully open position of the valve device 6. The pressure chamber housing 67 is constructed such that in this position the flexible connecting member 65 lies against the inner wall 69 of the pressure chamber housing 67. The valve member 61 thus behaves more or less as a rigid component in this position. Experiments have shown that this enhances the overall stability of the control of the bioreactor.

The valve member 61 of the valve device has not only the function of opening or closing the gate 64, but also of forming a resistance between the channel portions 204 and 201. Resistance is created when the valve member 61 assumes a limited open position. Said resistance is related to the quantitative value of the liquid flow through the valve device 6 owing to the presence of (compressible) air as a loading agent, but also owing to the flexibility of the valve member 61 and more in particular the closing edge 62 thereof. As the liquid flow increases, the valve member 61 will automatically assume a more open position, whereby its resistance decreases. This corresponds to the resistance behaviour of arteries and veins in the human body.

FIG. 4a is a cross-sectional view of the liquid chamber 3 in the non-loaded state, in which the liquid chambers 3 and 5 are mutually identically constructed in the embodiment of the invention described here. The liquid chamber 3 comprises a flexible wall portion 30 and a rigid wall portion 32. The flexible wall portion 30 has a convex shape and the rigid wall portion 32 also has a convex, but oppositely oriented shape. These two wall portions are fastened to one another by means of a lip seal 33. The lip seal 33 comprises two lips 34, 34′ which bear on a wall portion 36. The wall portion 36 is made from rigid material and is connected to the flexible wall portion 30. The two lips 34, 34′ are pressed against the wall portion 36 as a result of an underpressure provided between the lips via a connection that is not shown, and thus seal the liquid chamber 3 off from the exterior. At the outer side of the flexible wall portion 30 there is a pneumatic pressure chamber 37 that is separated from the outer atmosphere by a pressure chamber housing 38. Changing of the air pressure in the pneumatic pressure chamber 37 by means of a supply or discharge of compressed air through a gate 39 leads to a deformation of the flexible wall portion 30, whereby the volume of the liquid chamber is changed. FIGS. 4a, 4b, and 4c depict three positions of the flexible wall portion 30: FIG. 4a in the non-loaded state, FIG. 4b in a somewhat loaded state, and FIG. 4c in a more strongly loaded state. The deformation region 35 of the flexible wall portion 30 is visible in the loaded state. The rigidity of the flexible wall portion 30 is dependent exclusively on the thickness of the deformation region 35.

As was noted above, the basis of the embodiment of the bioreactor according to the invention is formed by the two identical housing parts 11 and 12. FIG. 5 shows the housing part 11 in a 30 representation. The individual chambers and valve devices that form part of the housing part 11 were rotated in the plane of drawing of FIG. 2 such that a clear visualization of the construction and functions is made possible. The various components are mutually positioned in the actual manufactured bioreactor in the way as shown in FIG. 5. This layout makes the housing part 11 compact and easy to manufacture. The same holds for the housing part 12, which is identical to the housing part 11.

As was noted above, the housing part 11, and accordingly also the housing part 12, comprises a combination of rigid and flexible portions which are manufactured in one mould as an injection-moulded product. A two-component injection moulding technique is used for this which is known to those skilled in the art. FIG. 6 shows the flexible portions 101 and 102 separately from the rigid portions 103 and 15. The cover 15, which is a rigid component of the housing part 11, is connected to the rigid portion 103 via a flexible hinge 16 of the flexible portion 102 (hinge 16 is not shown in FIG. 2). FIG. 6 shows particularly clearly that the flexible connecting member 65 of the valve device 6 and the flexible connecting members of the valve devices 601 and 602 together with the flexible hinge 16 and the flexible wall portion 30 of the first liquid chamber 3 form one integral whole. This simplifies the injection moulding process considerably.

FIG. 7 shows a flexible portion 102′ as an alternative embodiment of the flexible portion 102. FIG. 6 is a view from above, whereas FIG. 7 is a view from below. The inner side of the flexible wall portion 30′ is provided with ribs 301 projecting towards the inner side of the convex shape, unlike in the embodiment of the flexible portion 102 of the flexible wall portion 30 of FIG. 6. The ribs 301 divide the convex shape into wedge-shaped portions. The ribs 301 serve to make the deformation of the flexible wall portion 30′ more predictable during operation.

Now that all components of the embodiment of the bioreactor according to the present invention have been described, a description will be given by way of example of the manner in which the bioreactor according to the present invention can be used in the manufacturing process of an aortic valve.

When the cover 15 of the product chamber is opened, an adapter 40 provided with a scaffold of the heart valve 41 to be manufactured, more in particular an aortic valve, can be placed in the product chamber 4. Cells of a patient are placed on the scaffold. The cover 15 is closed and the bioreactor is filled via gate 74 with a nutrient liquid in the manner described above.

FIG. 8 is a graph representing the growing phase of an aortic valve in which the liquid pressure in the left ventricle (LPV), i.e. in the first liquid chamber 3, is plotted against the volume in the left ventricle (LV volume), i.e. the volume of the first liquid chamber 3. The broken line EDPVR gives the relation between pressure and volume at the end of the diastole. The broken line ESPVR gives the relation between pressure and volume at the end of the systole. The continuous full line gives the relation between pressure and volume during the growing phase. During this growing phase, the pressure difference across the heart valve is varied with the object of simulating—at a comparatively low level—the closing force of the aortic valve in vivo. A major portion of the cell growth of the heart valve takes place in the growing phase. Only the valve devices 601 and 604 are open in the growing phase. Since the valve 6 is closed, there is no circulation of liquid in this phase. The pressure in the first liquid chamber 3 is kept at a constant, low level, whereas the pressure in the second liquid chamber is varied in a pulsatory manner. Deformation caused by a continuously rising pressure difference across the aortic valve causes a continuously increasing displacement of liquid, so that the tissue of the aortic valve is not damaged.

FIG. 9 is a graph similar to that in FIG. 8 and represents the conditioning phase. In this conditioning phase the aortic valve is loaded such that its tissue reinforces itself in the correct direction in that a continuously rising pressure difference is applied across the valve and a continuously increasing volume displacement is applied through the valve. The simulation of the profile shown in FIG. 9 takes place in the same manner as in the test phase, which will be described below.

FIG. 10 is a graph similar to those described above and shows the typical in vivo pressure/volume characteristic of a left ventricle which is to be simulated during the test phase of the aortic valve to be grown. During the simulation of section a (in FIG. 10) all valve devices are opened except valve device 605. The open valve device 6 imitates an open mitral valve in vivo. The volume of the first liquid chamber 3 is enlarged, and the pressure is controlled to the level of the aortic pressure during the in vivo heart beat by means of the change in volume applied to the second liquid chamber 5 relative to the first liquid chamber 3, during which the position of the valve device 6 is controlled such that it realizes the required pressure difference between the first and the second liquid chamber. The valve device 6 is closed during the simulation of the sections b and c (in FIG. 10) so as to imitate the behaviour of the mitral valve. A liquid flow is now generated that corresponds to the aortic liquid flow in vivo. During this phase, again, the pressure is controlled to the level of the aortic pressure during the in vivo heart beat through a relative change in the volume of the second liquid chamber 5. The liquid flow decreases and the aortic valve closes (automatically) at the end of section c. The valve device 6 is opened again during the simulation of phase d so as to imitate the opening of the mitral valve. The test phase serves to ascertain whether a heart valve (after growing and conditioning, if applicable) has the desired properties.

FIG. 11 shows the pressure and liquid curves that are to be imitated during a (simulated) heart beat. The pressure is plotted on the left vertical pressure (P_{Iv}) being given as a function of time. The liquid flow (Q) is plotted on the right vertical axis, the graph showing the liquid flow in the aorta (Q). The difference between the aortic pressure curve and the left ventricle pressure curve represents the pressure difference across the aortic valve. This pressure difference can be accurately simulated through a continuous variable changing of the position of the valve member 61 of the valve device 6.

After the aortic valve has been grown, conditioned, and tested in the manner described above, and the test results are satisfactory, the liquid can be drained off, the cover 15 can be opened, and the adapter with the aortic valve thus manufactured can be taken from the bioreactor, after which the aortic valve can be implanted in the patient's heart.

The present invention is by no means limited to the manufacture of an aortic valve as in the embodiment described above. Given a suitable adapter, it is possible to manufacture, for example, veins or even a meniscus. The bioreactor according to the present invention offers the possibility of accurately simulating the physiological conditions that prevail in vivo for the relevant product to be manufactured also in these cases. The bioreactor is also eminently suitable for load-testing products other than those from medical tissue engineered, for example metal artificial heart valves. The physiological conditions can be accurately simulated also in these cases in order to carry out a durability test, whether or not accelerated, on the relevant valve, for example.

The above description merely gives an example of a possible embodiment of the present invention and should accordingly not be interpreted as limiting the latter. The invention is limited in principle by the ensuing claims only. Numerous embodiments are possible within the scope of the present invention. The device may also be used, for example, for synthesizing DNA. In that case, for example, a mixing device may be provided in the device shown in FIGS. 1 and 2 instead of the product chamber 4. In addition, one of the two liquid chambers 3 and 5 may not have to be used, and the valve device need not necessarily be adjustable in a continuously variable manner.

1. A device configured to subject an implantable medical product (41) to loads, the device comprising:
a continuous channel with a wall and configured to enable a liquid to flow in a flow direction, wherein, consecutively in or along the channel as seen in the flow direction, a first liquid chamber is provided with an adjustable volume, a product chamber is provided for accommodating the medical product that is to be put under load, a second liquid chamber is provided with an adjustable volume, and a valve device is provided with a valve member, which in a first, closed state, closes off the channel and in a second, open state, allows a flow through the continuous channel;
a flow mechanism configured to cause the liquid to flow through the continuous channel in the flow direction by changing the volume of the first liquid chamber, characterised; and
an operational mechanism configured to enable continuously variable adjustment of the valve member between the first state and the second state.

2. The device of claim 1, wherein the valve device further comprises an at least partly flexible connecting member configured to connect the valve member to a rigid portion of the wall of the continuous channel and, wherein the at least partly flexible connecting member is resilient.

3. (canceled)

4. The device of claim 2, wherein the at least partly flexible connecting member includes a portion of the wall of the continuous channel.

5. The device of claim 2, wherein the operational mechanism is configured to deform the at least partly flexible connecting member so as to adjust the position of the valve member.

6. The device of claim 5, wherein the operational mechanism further comprises a pneumatic pressure chamber at an outer side of the at least partly flexible connecting member, and a pneumatic pressure mechanism configured to change the pressure in the pneumatic pressure chamber.

7. (canceled)

8. The device of claim 1, wherein the valve member is at least partly flexible and/or resilient.

9. The device of claim 1, wherein the flow mechanism is further configured to cause liquid to flow through the continuous channel in the flow direction by changing the volume of the second liquid chamber.

10. The device of claim 1, wherein at least one of the liquid chambers includes an at least partly flexible and/or resilient wall.

11. The device of claim 10, wherein the flexible wall of at least one of the liquid chambers is made of a same material as the at least partly flexible connecting member and/or of the valve member.

12. The device of claim 10, wherein the flow is configured to deform the flexible wall of at least one of the liquid chambers so as to change the volume of the relevant liquid chamber or chambers.

13. The device of claim 12, wherein the flow mechanism further comprises at least one further pneumatic pressure chamber at an outer side of the flexible wall of at least one of the liquid chambers, and further a pneumatic pressure mechanism configured to adjust the pressure in the further pneumatic pressure chamber or chambers.

14. (canceled)

15. The device of claim 10, wherein the flexible wall of at least one of the liquid chambers has a substantially convex shape in a non-loaded state.

16. The device of claim 15, wherein the wall thickness of the convex flexible wall (30, 50) increases in a direction away from the top and/or the convex flexible wall is locally provided with thickened portions for guiding deformation regions towards non-thickened portions of the convex flexible wall in use.

17. (canceled)

18. The device of claim 15, wherein that portion of the wall of the liquid chamber that is located opposite the convex flexible wall has a convex shape.

19. The device of claim 15, wherein that portion of the wall of the liquid chamber that is located opposite the convex flexible wall is rigid.

20. The device of claim 1, wherein the liquid chambers are defined by a first housing part and a second housing part, which parts are interconnected in a liquid-proof manner.

21. The device of claim 20, wherein the device further comprises a sealing mechanism provided between the first housing part and the second housing part, which sealing mechanism comprises two lips which enclose a volume of reduced pressure between the two lips which achieves a suction joint between the first housing part and the second housing part.

22. The device of claim 21, the first housing part is injection-moulded and at least partly rigid, and the first housing part further comprises at least a portion of the at least partially flexible connecting member of the valve device and/or the flexible wall of the first and/or the second liquid chamber.

23. The device of claim 22, wherein the rigid portion of the wall of the liquid chamber is integral with the first housing part, whereas the flexible wall of the chamber is integral with the second housing part.

24. The device of claim 23, wherein the second housing part is injection-moulded, includes the rigid portion of the wall of the liquid chamber whose flexible wall is integral with the first housing part, and comprises the flexible wall of the liquid chamber whose rigid wall portion is integral with the first housing part.

25. The device of claim 20, wherein the first housing part and the second housing part have the same shape.

26.-30. (canceled)

31. A method of operating a device of claim 1, comprising mutually differently changing the volume of the first liquid chamber and the volume of the second liquid chamber so as to change the liquid pressure in at least one liquid chamber of the device.
